(19) United States
(12) Patent Application Publication
(10) Pub. No.: US 2017/0115870 A1
(43) Pub. Date: Apr. 27, 2017

(54) METHOD FOR DISPLAYING STROKES ON CANVAS

(71) Applicant: Fujian Foxit Software Development Joint Stock Co., Ltd., Fuzhou City (CN)

(72) Inventors: Yuqian Xiong, Fuzhou City (CN); Yinsen Yan, Fuzhou City (CN)

(21) Appl. No.: 15/317,299

(22) PCT Filed: Jun. 11, 2015
(86) PCT No.: PCT/CN2015/000399

§ 371 Date: Dec. 8, 2016

(30) Foreign Application Priority Data
Jun. 12, 2014 (CN) 201410262111.X

(51) Int. Cl. G06F 3/0488; G06F 3/041; G06T 11/00; G06F 3/0354

(52) U.S. Cl. CPC G06F 3/04883; G06F 3/03545; G06F 3/0416; G06T 11/001

(57) ABSTRACT

A method for displaying strokes on a canvas includes creating a canvas on a screen; determining the shape and size of stroke points displayed on the canvas, thus determining the distance between adjacent stroke points; recording an edge frame of a valid region coming into contact with a paintbrush in real time, wherein the valid region is a region on the screen located inside the edge of the canvas; according to the shape and size of the stroke points and the distance between the adjacent stroke points, determining positions of N stroke points on the canvas, so that all the valid regions coming into contact with the paintbrush are completely covered by the N stroke points, where N is an integer not less than 1; and refurbishing the colors of the regions corresponding to the N stroke points on the canvas from a base color to being colored.

### TECHNICAL FIELD

The present invention relates to the technical field of displaying strokes on a canvas, and in particular to a method for displaying strokes on a canvas.

### BACKGROUND ART

As development of technologies of touch screens, writing and painting on a screen has been popular. Firstly a canvas is created on the screen, which determines a region for writing and painting on the screen; secondly a stylus is used to come into contact with the canvas, thereby forming writing and painting tracks; and finally colors of all regions on the canvas are refreshed, wherein all pixels contacted by the stylus are displayed in a colored state, but the other pixels not contacted by the stylus are displayed in a background color state. In order to ensure the real time of writing and painting track displaying, the color of the canvas is refreshed once when the stylus is in contact with M pixels. It can be seen that in the prior art, colors of all the pixels of the canvas need to be frequently refreshed, and before and after writing and painting, colors of most of the pixels on the canvas are not changed and always keep the background color state. Therefore, in the prior art, refreshing of these color-unchanged pixels wastes a lot of time, and the display efficiency is also reduced.

### SUMMARY OF THE INVENTION

A technical problem to be solved by the present invention is to provide a method for displaying strokes on a canvas, which can improve the display efficiency.

In order to solve the technical problem as described above, the present invention provides a technical solution as follows: a method for displaying strokes on a canvas is provided, and the canvas is located on a screen; and the method comprises:

Step 1: creating a canvas on the screen;

Step 2: determining (a) shape(s) and (a) size(s) of stroke points displayed on the canvas, and then determining a contact distance between consecutive stroke points;

Step 3: recording borders of valid regions contacted by a stylus in real time, wherein the valid regions are regions located inside the edge(s) of the canvas on the screen;

Step 4: according to the shape(s) and the size(s) of the stroke points and the contact distance between the consecutive stroke points, determining positions of N stroke points on the canvas, and enabling the N stroke points to completely cover all the valid regions contacted by the stylus, wherein N is an integer not less than 1; and

Step 5: refreshing regions corresponding to the N stroke points on the canvas to (a) different color(s) from a background color.

The method for displaying the strokes on the canvas, provided by the present invention, has the beneficial effects: the positions of the N stroke points are determined according to the borders of the valid regions contacted by the stylus, the N stroke points cover all the valid regions contacted by the stylus, and only the colors of the regions corresponding to the N stroke points on the canvas are refreshed; compared with the prior art that the colors of all the pixels on the canvas are refreshed, the method provided by the present invention refreshes the colors of much fewer pixels, so that the refreshing load is largely reduced; and therefore, the display efficiency is improved.

On the basis of the technical solution, the following improvements can be implemented in the present invention.

Furthermore, N is an integer larger than 1; and then,

In the step 4, at least two consecutive stroke points of the N stroke points are tangent only at each edge position.

Furthermore, the shape of each stroke point is a rectangle.

Furthermore, N is equal to 1.

### BRIEF DESCRIPTION OF DRAWINGS

FIG. 1 is a flow chart of a method for displaying strokes on a canvas, provided by the present invention.

### DETAILED DESCRIPTION OF THE INVENTION

With reference to the accompanying drawings, the description of the principles and features of the present invention are given as following. The given examples are only applied to explaining the present invention, but not be applied to limit the scope of the present invention.

The present invention provides a method for displaying strokes on a canvas, wherein the canvas is a canvas located on a screen (such as a touch screen, a graphics tablet screen and the like), but not a canvas that is made of fabrics and is used for creating works, such as oil paintings and the like, in real life. Certainly, the strokes in the present invention are not handwritings written on paper or fabrics through pencils, pens and the like, but a collection of pixels contacted by a stylus on the screen. Additionally, the stylus in the present invention is any object, such as a finger, a hard object and the like, capable of leaving strokes by coming into contact with the screen.

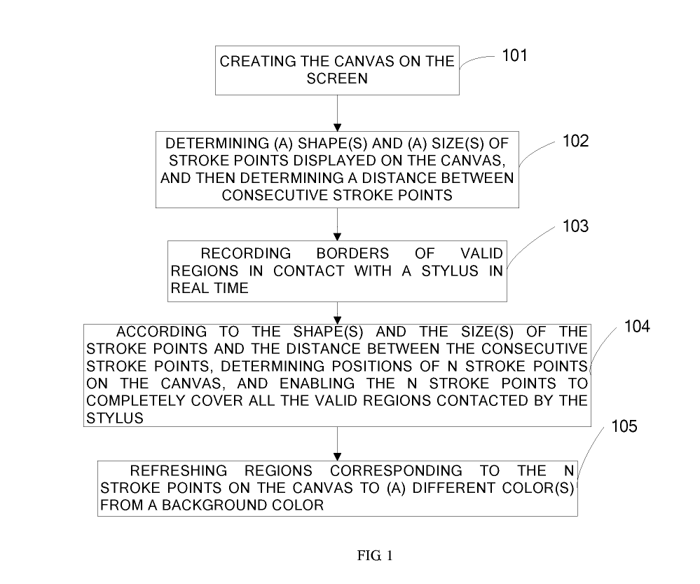

FIG. 1 is a flow chart of a method for displaying strokes on a canvas, provided by the present invention. As shown in FIG. 1, the method comprises the following steps:

Step 101: creating a canvas on a screen.

In this step, creating a canvas on a screen means in a memory, developing a specific region only used for storing data associated with the canvas, namely, creating a memory bitmap and enabling the memory bitmap to correspond to the canvas. The data in the memory bitmap are in one to one correspondence with characteristics, such as positions, colors and the like, of the pixels on the canvas.

In the invention, all regions occupied by the canvas in the present invention are located inside the edge(s) of the canvas. Furthermore, the canvas is located on the screen, and the regions occupied by the canvas may be only a part of the screen, be a whole of the screen, and even be larger than the screen. And when the regions occupied by the canvas are larger than the screen, the screen only displays a part of the canvas all the time. And when the canvas is dragged, the screen can display the other part of the canvas.

Step 102: determining (a) shape(s) and (a) size(s) of stroke points displayed on the canvas, and then determining a contact distance between consecutive stroke points.

In the present invention, the stroke points are basic elements forming the strokes, which means that one stroke can be taken as a collection of a plurality of stroke points. Each stroke point has a shape and a size that are determined in this step. One stroke point can be only one pixel, so that its shape is a point, and its size is one. Each stroke point further comprises more than two pixels which are connected to form a certain shape; and the shape of the stroke point is random, such as a square, a rectangle, a rhombus, a circle, a line and the like. Once one stroke point has a shape, it has a size. According to the difference of the shapes, description methods of the sizes are different from each other. For example, if the shape of one stroke point is a circle, the size of such stroke point can be described by a radius. However, when the shape of the stroke point is a rectangle, the size thereof is described by a length and a width. And the sizes of other stroke points in the other shapes are described in the same manner. In one preferred embodiment, the shape of the stroke points are a rectangle.

In this step, the shape(s) and the size(s) of the stroke points can be determined manually, for example, the shape and size of one stroke point are determined in a manually drawing manner, or are determined by a user in the form of a dialog box. Additionally, the shape(s) and the size(s) of the stroke points can be determined automatically, that is, the shape(s) and the size(s) of the stroke points utilize(s) the system default settings.

The strokes are formed by a plurality of stroke points, and once the stroke points have the shape(s) and the size(s), the contact distance between consecutive stroke points can be determined. In the present invention, the contact distance is a maximum distance which the two consecutive stroke points can achieve when the two consecutive stroke points needs to achieve an adjacency purpose (namely, ensuring that the stroke points are continuous or successive to the human eyes), wherein such adjacency means that two stroke points may have (a) shared pixel(s), that is, a part of pixels of the two stroke points are superposed, and such situation can be called as that the two stroke points are in an intersecting state. The limit of such intersecting state is: the shared pixels existing between the two stroke points are gradually reduced to be 0, and at this point, the two stroke points are in a tangent state. Besides, under situations difficult to distinguish to human eyes, the two stroke points can be in a separation state, that is, the two stroke points do not have any shared pixel. Only when the distance between the two consecutive stroke points is smaller than a minimum distance which can be distinguished by human eyes, the stroke points are still seen as continuous to the human eyes, and such situation also falls into the scope of the present invention. Certainly, the contact distance between the stroke points further can be in other states, for example, the two consecutive stroke points have a superposed region, that is, the shared pixels between the two consecutive stroke points are connected and then form a sealed region.

Step 103: recording borders of valid regions contacted by a stylus in real time.

In this step, the valid regions are regions located inside the edge(s) of the canvas on the screen, that is, other regions out of the edge of the canvas on the screen do not belong to the valid regions. Even if the stylus comes into contact with non-valid regions, no stroke is displayed on the canvas.

A Part inside the borders of the valid regions are strokes formed by the stylus after coming into contact with the screen. In the present invention, only the borders of the valid regions contacted by the stylus are recorded, thereby greatly reducing the data volume, and then improving the operation efficiency.

In this step, real-time recording is: while a sensor on the screen receives the pressure of the stylus, the sensor immediately sends the pressure data to a controller, and the controller instantly stores the pressure data in the memory bitmap in the step 101 and builds a correspondence relation with pixels at the position of the sensor. Besides, the real-time recording also creates conditions for real-time refreshing in the step 105.

Step 104: according to the shape(s) and the size(s) of the stroke points and the contact distance between the consecutive stroke points, determining positions of N stroke points on the canvas, and enabling the N stroke points to completely cover all the valid regions contacted by the stylus.

In this step, N is an integer not less than 1.

In this step, all the valid regions contacted by the stylus recorded in the step 103 are covered by setting the N stroke points, so that strokes formed by the stylus after coming into contact with the screen are displayed on the screen. The coverage can be complete coverage, and also can be partial coverage. The two consecutive stroke points can be in contact with each other only at edges, alternatively can have a superposed region, and even alternatively can be separated.

Step 105: refreshing regions corresponding to the N stroke points on the canvas to (a) different color(s) from a background color.

This step is a refreshing step in the present invention, which is a step of refreshing pixels of some regions on the canvas to (a) different color(s) from the background color. After the paint brush comes into contact with a certain valid region, pixels in the valid region are changed from the background color to be in a predefined color, such as a black color.

When the stylus is in contact with the screen, the step 103 to the step 105 are performed in real time, that is, the valid regions contacted by the stylus are displayed in real time in the step 105, and the colors of the other valid regions in non-contact with the stylus are not refreshed.

It can be seen that: in the present invention, the positions of the N stroke points are determined according to the borders of the valid regions contacted by the stylus, the N stroke points cover all the valid regions contacted by the stylus, and only the colors of the regions corresponding to the N stroke points on the canvas are refreshed, so that compared with the prior art that the colors of all pixels on the canvas need to be refreshed, the present invention only refreshes much fewer pixels, result in largely reducing the refreshing workload; therefore, the display efficiency is improved.

The value of N is associated with the shape(s) and the size(s) of the stroke points and the quantity of the valid regions. If the step 104 and the step 105 are performed once when a preset quantity (such as X) of valid regions are recorded in the step 103 for each time, the value of N is only associated with the shape(s) and the size(s) of the stroke points.

The fact that N is equal to 1 can be achieved by setting the shape(s) and the size(s) of the stroke points and the value of X, and at this point, the refreshing speed in the step 105 is the highest, and the display efficiency is also highest in real time.

A method for reducing the value of N is to enable the most consecutive stroke points to be tangent only at each edge position, so that a purpose of visually continuous strokes can be achieved, and the value of N can be reduced. Therefore, one preferred embodiment for reducing the value of N in the present invention is as follows:

When N is an integer larger than 1, at least two consecutive stroke points in the N stroke points are tangent only at each edge position.

Certainly, when the consecutive stroke points are in the separation state, as long as the distance is sufficiently small and is difficult to be distinguished by the human eyes, a purpose of visually continuous strokes can also be achieved. Such situation can further reduce the value of N and also falls into the scope of the present invention.

It can be know that the method for displaying the strokes on the canvas, provided by the present invention, has the following advantages:

(1), the positions of the N stroke points are determined according to the borders of the valid regions contacted by the stylus. Therefore, the N stroke points cover all the valid regions contacted by the stylus. And then, only the colors of the regions corresponding to the N stroke points on the canvas are refreshed. In comparison with the prior art that the colors of all the pixels on the canvas are refreshed, the method provided by the present invention refreshes the colors of much fewer pixels, so that the refreshing load is largely reduced; and therefore, the display efficiency is improved.

Merely preferred embodiments of the present invention are described herein, and the present invention is not limited thereto. Any modification, equivalent replacement, or improvement made without departing from the spirit and principle of the present invention shall fall within the scope of the present invention.

1. A method for displaying strokes on a canvas, wherein, the canvas is located on a screen; the method comprising:
creating the canvas on the screen;
determining a shape and a size of stroke points displayed on the canvas, and then determining a contact distance between consecutive stroke points;
recording borders of valid regions contacted by a stylus in real time, wherein the valid regions are regions located inside edges of the canvas on the screen;
according to the shape and the size of the stroke points and the contact distance between the consecutive stroke points, determining positions of N stroke points on the canvas, and enabling the N stroke points to completely cover all the valid regions contacted by the stylus, wherein N is an integer not less than 1; and
refreshing regions corresponding to the N stroke points on the canvas to different colors from a background color.

2. The method according to claim 1, wherein, N is an integer larger than 1; and in the determining positions of N stroke points on the canvas, and the enabling the N stroke points to completely cover all the valid regions contacted by the stylus, at least two consecutive stroke points of the N stroke points are tangent only at each edge position.

3. The method according to claim 1, wherein, the shape of each stroke point is a rectangle.

4. The method according to claim 1, wherein, N is equal to 1.
